(19) United States
(12) Patent Application Publication
(10) Pub. No.: US 2023/0280959 A1
(43) Pub. Date: Sep. 7, 2023

(54) NON-TRANSITORY COMPUTER READABLE STORAGE MEDIUM STORING PRINT CONTROL PROGRAM

(71) Applicant: SEIKO EPSON CORPORATION, Tokyo (JP)

(72) Inventors: Masaharu IWAMOTO, Shiojiri-shi (JP); Yukiko SHIKATA, Matsumoto-shi (JP)

(21) Appl. No.: 18/174,774

(22) Filed: Feb. 27, 2023

(30) Foreign Application Priority Data
Mar. 1, 2022 (JP) 2022-030978

(51) Int. Cl. G06F 3/12; H04N 1/00

(52) U.S. Cl. CPC G06F 3/1267; G06F 3/1287; G06F 3/1203; H04N 1/00472

(57) ABSTRACT

A non-transitory computer readable storage medium storing a print control program, the print control program, corresponding to a printing device registered in an operating system of an information terminal, the print control program includes, when the printing device is a device of a VPN connection destination, generating, before transmitting print data to the printing device, a user interface including a confirmation screen to confirm with the user that print output is from the printing device.

The present application is based on, and claims priority from JP Application Serial Number 2022-030978, filed Mar. 1, 2022, the disclosure of which is hereby incorporated by reference herein in its entirety.

### BACKGROUND

### 1. Technical Field

The present disclosure relates to a print control program corresponding to a printing device registered in an operating system of an information terminal.

### 2. Related Art

Technology for preventing erroneous transmission of print data has been proposed.

In JP-A-2010-97479, a print process is described in which, among a plurality of image forming apparatuses registered in a computer, the user's use objective is estimated from features in the print data and is selected, an image forming apparatus of a selected print output destination is depicted and the user's confirmation is prompted, and printing is performed after confirmation. According to such a print process, an erroneous transmission of print data can be prevented and security can be enhanced.

In recent years, there has been an increasing number of users who alternately work at the office and at home, and there has been a problem that print data for private use at home is erroneously transmitted to a printer installed in the office. Occurrence occurs more notably due to the “normally used printer” being registered in the function of the operating system of the computer or the application software storing the previously used printer.

Although such a problem can be avoided by using the print process described in JP-A-2010-97479, it is inconvenient because the confirmation screen appears every time printing is performed. In particular, for security reasons, many users working at home refrain from printing out documents relating to business from a printer installed at home, and in this case, the frequency of printing out documents relating to business from a printer installed in an office increases, the confirmation screen frequently appears during office work, and degradation in business efficiency becomes significant.

### SUMMARY

In order to solve the above problem, a non-transitory computer readable storage medium storing a print control program, the print control program, according to this disclosure, corresponding to a printing device registered in an operating system of an information terminal, the print control program includes, when the printing device is a device of a VPN connection destination, generating, before transmitting print data to the printing device, a user interface including a confirmation screen to confirm with the user that print output is from the printing device.

Further, a non-transitory computer readable storage medium storing a print control program, the print control program, according to this disclosure, corresponding to a printing device registered in an operating system of an information terminal, the print control program includes, when the printing device is a device of a VPN connection destination, selecting a print suspension process that suspends print output from the printing device and that stores print data in a storage section included in the printing device.

Further, a non-transitory computer readable storage medium storing a print control program, the print control program, according to this disclosure, corresponding to a printing device registered in an operating system of an information terminal, the print control program includes, when the printing device is a device of a VPN connection destination, providing information that the printing device is non-selectable with respect to an application program running on the operating system.

Further, a non-transitory computer readable storage medium, according to this disclosure, corresponding to a printing device registered in an operating system of an information terminal, the print control program further includes, when a network environment of the information terminal is different from a network environment to which the printing device belongs, generating, before transmitting print data to the printing device, a user interface including a confirmation screen to confirm with the user that print output is from the printing device.

Further, a non-transitory computer readable storage medium, according to this disclosure, corresponding to a printing device registered in an operating system of an information terminal, the print control program further includes, when a network environment of the information terminal is different from a network environment to which the printing device belongs, selecting a print suspension process that suspends print output from the printing device and that stores print data in a storage section included in the printing device.

Further, a non-transitory computer readable storage medium, according to this disclosure, corresponding to a printing device registered in an operating system of an information terminal, the print control program further includes, when a network environment of the information terminal is different from a network environment to which the printing device belongs, providing information that the printing device is non-selectable with respect to an application program running on the operating system.

Further, a non-transitory computer readable storage medium, according to this disclosure, corresponding to a printing device registered in an operating system of an information terminal, the print control program further includes, when a network environment of the information terminal is different from a default network environment, wherein the default network environment is defined as a network environment in which print output from the printing device was most performed in the past, generating, before transmitting print data to the printing device, a user interface including a confirmation screen to confirm with the user that print output is from the printing device.

Further, a non-transitory computer readable storage medium, according to this disclosure, corresponding to a printing device registered in an operating system of an information terminal, the print control program further includes, when a network environment of the information terminal is different from a default network environment, wherein the default network environment is defined as a network environment in which print output from the printing device was most performed in the past, selecting a print suspension process that suspends print output from the printing device and that stores print data in a storage section included in the printing device.

Further, a non-transitory computer readable storage medium, according to this disclosure, corresponding to a printing device registered in an operating system of an information terminal, the print control program further includes, when a network environment of the information terminal is different from a default network environment, wherein the default network environment is defined as a network environment in which print output from the printing device was most performed in the past, providing information that the printing device is non-selectable with respect to an application program running on the operating system.

### BRIEF DESCRIPTION OF THE DRAWINGS

FIG. 1 is a diagram showing overall configuration of a network.

FIG. 2 is a block diagram illustrating configuration of an information terminal.

FIG. 3 is a block diagram illustrating configuration of a printing device.

FIG. 4 is a flowchart showing processes of a print control program according to a first embodiment.

FIG. 5 is a diagram showing a user interface (UI) generated by the print control program according to the first embodiment.

FIG. 6 is a flowchart showing processes of a print control program according to a second embodiment.

FIG. 7 is a diagram showing a UI generated by the print control program according to the second embodiment.

FIG. 8 is a flowchart showing processes of a print control program according to a third embodiment.

FIG. 9 is a diagram showing a print setting screen in an application program.

FIG. 10 is a flowchart showing processes of a print control program according to a fourth embodiment.

FIG. 11 is a diagram showing a UI generated by the print control program according to the fourth embodiment.

FIG. 12 is a flowchart showing processes of a print control program according to a fifth embodiment.

FIG. 13 is a diagram showing a UI generated by the print control program according to the fifth embodiment.

FIG. 14 is a flowchart showing processes of a print control program according to a sixth embodiment.

FIG. 15 is a flowchart showing processes of a print control program according to a seventh embodiment.

FIG. 16 is a diagram showing a UI generated by the print control program according to the seventh embodiment.

FIG. 17 is a flowchart showing processes of a print control program according to an eighth embodiment.

FIG. 18 is a diagram showing a UI generated by a print control program according to the eighth embodiment.

FIG. 19 is a flowchart showing processes of a print control program according to a ninth embodiment.

### DESCRIPTION OF EMBODIMENTS

The following is a schematic description of this disclosure.

A print control program according to a first aspect is a print control program corresponding to a printing device registered in an operating system of an information terminal, wherein when the printing device is a device of a VPN connection destination, the print control program generates a user interface including a confirmation screen for confirming a user about a print output from the printing device before transmitting print data to the printing device.

Hereinafter, the term “user interface” is abbreviated to “UI”. In the following description, for convenience of explanation, it is assumed that the printing device is located in an office and the information terminal operated by the user is located outside the office, but the present disclosure is not limited to this. In the following description, erroneous printing means that print data is erroneously transmitted from outside the office to a printing device in the office and print output is executed.

The user accesses the network of the office from outside by using a VPN connection for security reasons. Therefore, when the printing device is a device of a VPN connection destination, a UI is generated that includes a confirmation screen for confirming with the user that print output is from the printing device before print data is transmitted to the printing device, so that it is possible to suppress erroneous printing and to ensure security by displaying the UI outside the office. Also, at the office, the UI is not displayed every time printing is performed. Therefore, it is possible to suppress degradation in business efficiency.

A print control program according to a second aspect is a print control program corresponding to a printing device registered in an operating system of an information terminal, wherein when the printing device is a device of a VPN connection destination, the print control program selects a print suspension process that holds a print output from the printing device and stores print data in a storage section included in the printing device.

According to this aspect, when the printing device is a device of a VPN connection destination, the print suspension process is selected. The print suspension process is a process for suspending print output from the printing device and storing the print data in the storage section included in the printing device. Therefore, it is possible to suppress erroneous printing and to ensure security outside the office. Since selection and non-selection of the print suspension process are automatically switched in this way, degradation in business efficiency can be suppressed.

A print control program according to a third aspect is a print control program corresponding to a printing device registered in an operating system of an information terminal, wherein when the printing device is a device of a VPN connection destination, the print control program provides an information that the printing device is in non-selectable to an application program running on the operating system.

According to this aspect, when the printing device is a device of a VPN connection destination, information indicating that the printing device is non-selectable is provided to an application program that operates on the operating system. Therefore, outside the office, the application program does not show the printing device outside the office, and it is possible to suppress erroneous printing and to ensure security. Since the selectable state and the non-selectable state of the printing device are automatically switched, the degradation in business efficiency can be suppressed.

A print control program according to a fourth aspect is a print control program corresponding to a printing device registered in an operating system of an information terminal, wherein when the network environment of the information terminal is different from the network environment to which the printing device belongs, the print control program generates a UI including a confirmation screen for with a user that print output is from the printing device before transmitting print data to the printing device.

According to this aspect, when the network environment of the information terminal is different from the network environment to which the printing device belongs, the UI is generated that includes a confirmation screen for confirming with a user that print output is from the printing device before print data is transmitted to the printing device, whereby it is possible to suppress erroneous printing and to ensure security by displaying the UI outside the office. Also, at the office, the UI is not displayed every time printing is performed. Therefore, it is possible to suppress degradation in business efficiency.

A print control program according to a fifth aspect is a print control program corresponding to a printing device registered in an operating system of an information terminal, wherein when the network environment of the information terminal is different from the network environment to which the printing device belongs, the print control program selects a print suspension process that holds a print output from the printing device and stores print data in a storage section included in the printing device.

According to this aspect, when the network environment of the information terminal is different from the network environment to which the printing device belongs, the print suspension process is selected. The print suspension process is a process for suspending the print output from the printing device and storing the print data in the storage section included in the printing device. Therefore, it is possible to suppress erroneous printing outside the office and to ensure security. Since the selectable state and the non-selectable state of the printing device are automatically switched, the degradation in business efficiency can be suppressed.

A print control program according to a sixth aspect is a print control program corresponding to a printing device registered in an operating system of an information terminal, wherein when the network environment of the information terminal is different from the network environment to which the printing device belongs, the print control program provides the information that the printing device is in non-selectable to an application program running on the operating system.

According to this aspect, when the network environment of the information terminal is different from the network environment to which the printing device belongs, information indicating that the printing device is non-selectable is provided to an application program that operates on the operating system. Therefore, outside the office, the application program does not show the printing device, and it is possible to suppress erroneous printing outside the office and to ensure security. Since the selectable state and the non-selectable state of the printing device are automatically switched, the degradation in business efficiency can be suppressed.

A print control program according to a seventh aspect is a print control program corresponding to a printing device registered in an operating system of an information terminal, wherein a network environment in which print output from the printing device is performed the most in the past is defined as a default network environment, and when the network environment of the information terminal is different from the default network environment, the print control program generates a UI including a confirmation screen for confirming with a user that print output is from the printing device before transmitting print data to the printing device.

When the network environment of the information terminal is different from the default network environment, there is a high possibility that the information terminal is outside the office. According to this aspect, in a case where the network environment of the information terminal is different from the default network environment, the UI including the confirmation screen for confirming with the user that the print output is from the printing device is generated. Therefore, it is possible to suppress erroneous printing and to ensure security by displaying the UI outside the office. Also, at the office, the UI is not displayed every time printing is performed. Therefore, it is possible to suppress degradation in business efficiency.

A print control program according to an eighth aspect is a print control program corresponding to a printing device registered in an operating system of an information terminal, wherein a network environment in which print output from the printing device is performed the most in the past is defined as a default network environment, and when the network environment of the information terminal is different from the default network environment, the print control program selects a print suspension process that holds a print output from the printing device and stores print data in a storage section included in the printing device.

When the network environment of the information terminal is different from the default network environment, there is a high possibility that the information terminal is outside the office. According to this aspect, in a case where the network environment of the information terminal is different from the default network environment, the print suspension process is selected. The print suspension process is a process for suspending the print output from the printing device and storing the print data in the storage section included in the printing device. Therefore, it is possible to suppress erroneous printing outside the office and to ensure security. Since the selectable state and the non-selectable state of the printing device are automatically switched, the degradation in business efficiency can be suppressed.

A print control program according to a ninth aspect is a print control program corresponding to a printing device registered in an operating system of an information terminal, wherein a network environment in which print output from the printing device is performed the most in the past is defined as a default network environment, and when the network environment of the information terminal is different from the default network environment, the print control program provides the information that the printing device is in non-selectable to an application program running on the operating system.

When the network environment of the information terminal is different from the default network environment, there is a high possibility that the information terminal is outside the office. According to this aspect, when the network environment of the information terminal is different from the default network environment, the information indicating that the printing device is non-selectable is provided to an application program that operates on the operating system. Therefore, outside the office, the application program does not show the printing device, and it is possible to suppress erroneous printing outside the office and to ensure security. Since the selectable state and the non-selectable state of the printing device are automatically switched, the degradation in business efficiency can be suppressed.

Hereinafter, the present disclosure will be specifically described.

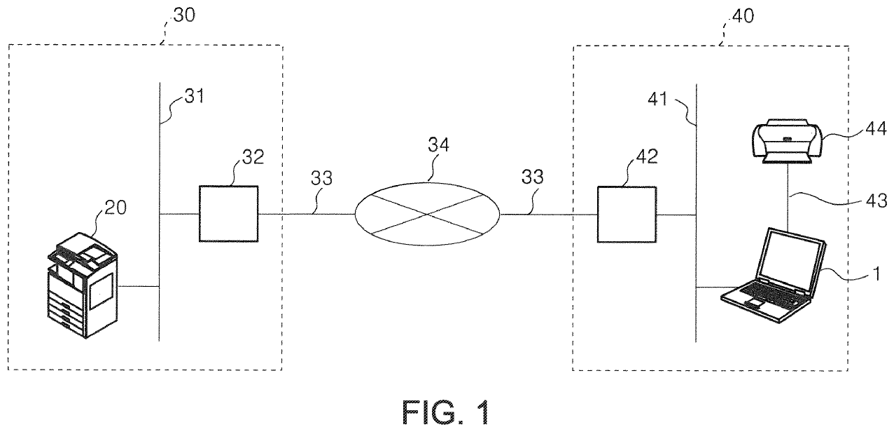

In FIG. 1, reference numeral 30 denotes an office area, and reference numeral 40 denotes an out-of-office area. An example of the out-of-office area is a home area of a user who works in an office.

A local area network (hereinafter referred to as “LAN”) 31 is provided in the office area 30, and a printing device 20 is connected to the LAN 31. The printing device 20 is, for example, a multi-function printer including an inkjet printer and a scanner.

The LAN 31 is also connected to an Internet 34 via a gateway 32. The gateway 32 is configured by a router or the like. The LAN 31 can also connect to the Internet 34 via a VPN 33 as needed. VPN is an abbreviation of Virtual Private Network and is a virtual private line.

A LAN 41 is provided in the out-of-office area 40, and an information terminal 1 is connected to the LAN 41. The information terminal 1 is, for example, a personal computer. A printing device 44 is connected locally to the information terminal 1, and is connected by a USB cable 43 as an example. USB is an abbreviation for Universal Serial Bus. As an example, the printing device 44 is an inkjet printer.

The LAN 41 is also connected to the Internet 34 via a gateway 42. The gateway 42 is configured by a router or the like. The information terminal 1 can also be connected to the Internet 34 through the VPN 33 as necessary.

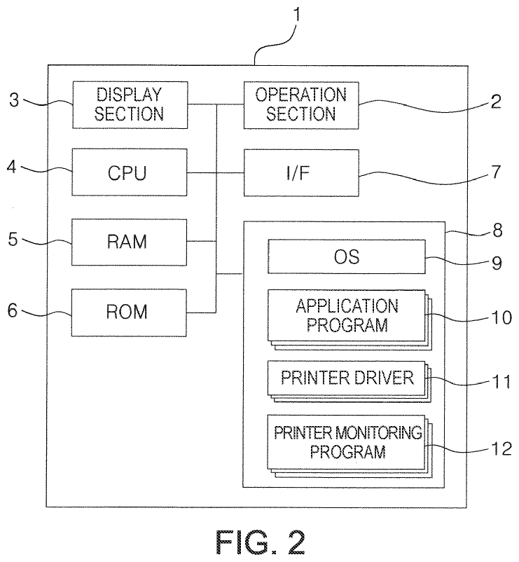

The configuration of the information terminal 1 will be described with reference to FIG. 2.

The information terminal 1 includes an operation section 2, a display section 3, a CPU 4, a RAM 5, a ROM 6, a storage 8, and an interface (hereinafter referred to as an “I/F”) 7.

The storage 8 includes a hard disk drive (HDD), a solid state drive (SSD), a USB memory, and the like. The storage 8 stores various programs and various data such as an operating system (hereinafter referred to as “OS”) 9, an application program 10, a printer driver 11, and a printer monitoring program 12.

The OS 9, for example, is Windows (a registered trademark of Microsoft Corporation). The printing device 20 and 44 are registered as available devices in a device list in the OS 9, and for example, the printing device 20 is registered as a “normally used printer”.

Note that there is not necessarily only one each of the application program 10, the printer driver 11, and the printer monitoring program 12, but in most cases, a plurality of each is stored. Of the printer monitoring programs 12, the one that corresponds to the above-described printing device 20 is a print control program according to the present disclosure.

The CPU 4 expands various programs and the like stored in the ROM 6 and the storage 8 into the RAM 5, which is a volatile memory, and executes them.

The operation section 2 includes a keyboard and a pointing device such as a mouse or a touchpad. The display section 3 is configured by a liquid crystal display or the like. On the display section 3, various UIs are generated by the OS 9, the application program 10, the printer driver 11, the printer monitoring program 12, or the like.

The I/F 7 includes a communication interface for connecting the information terminal 1 to the LAN 41 and a connection interface for communicating with various peripheral devices connected to the information terminal 1.

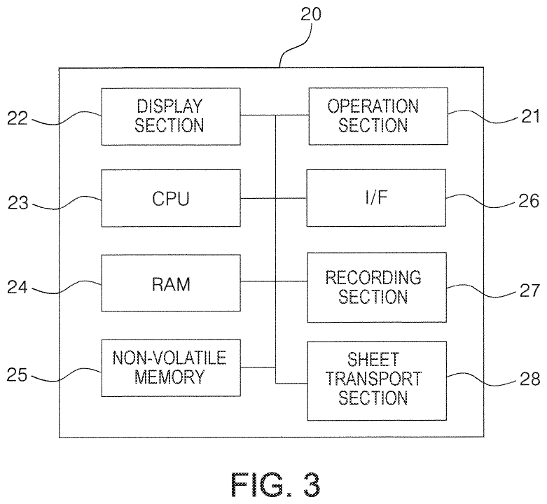

Next, configuration of the printing device 20 will be described with reference to FIG. 3.

The printing device 20 includes an operation section 21, a display section 22, a CPU 23, a RAM 24, a non-volatile memory 25, an I/F 26, a recording section 27, and a sheet transport section 28.

The CPU 23 expands various control programs and the like stored in the non-volatile memory 25 into the RAM 24, which is a volatile memory, and executes them.

The operation section 21 includes a numeric keypad, an arrow key, an enter key, a backspace key (none of which are illustrated), and the like.

The display section 22 is configured by a liquid crystal display or the like. Various UIs are displayed on the display section 22.

The I/F 26 includes a communication interface for connecting the printing device 20 to the LAN 31. The recording section 27 includes an inkjet recording head (not shown). The sheet transport section 28 includes a sheet transport roller (not shown) and the like.

Next, the printer monitoring program 12 will be described.

When the information terminal 1 executes printing from the application program 10 such as an electronic document or a spreadsheet, the OS 9 starts the printer driver 11, and the printer driver 11 starts the printer monitoring program 12. In addition to the case where printing was executed from the application program 10, the printer monitoring program 12 may be activated at the timing when the printing screen of the application program 10 is activated. The printer driver 11 generates print data based on the data received from the application program 10. The print data is transmitted to the printing device 20 via a spooler (not shown).

The printer monitoring program 12 is a program sometimes referred to as a status monitor, and its basic function is to communicate with the printing device 20 and determine abnormalities such as paper jam, out of ink, cover open, and the like. When such an abnormality occurs, the printer monitoring program 12 displays the contents of the abnormality on the display section 3 of the information terminal 1 and notifies the user.

### First Embodiment

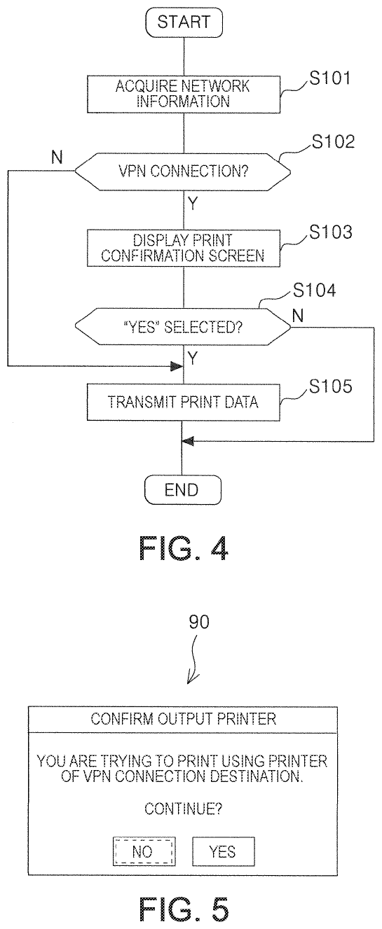

A first embodiment of the printer monitoring program 12 will be described with reference to FIGS. 4 and 5. In the following description, the printer monitoring program according to the first embodiment will be described using reference numeral 12A.

FIG. 4 shows a process performed when the printer monitoring program 12A receives a print instruction from the application program 10. When the printer monitoring program 12A receives a print instruction from the application program 10, it acquires network information (step S101). In this embodiment, the network information is information indicating whether the information terminal 1 is VPN-connected, and when the information terminal 1 is VPN-connected by the OS 9 function, then, for example, information can be acquired from the OS 9.

Next, when the information terminal 1 is VPN-connected (Yes in step S102), then the printer monitoring program 12A displays a print confirmation screen on the display section 3 of the information terminal 1 (step S103). This print confirmation screen is a confirmation screen for confirming with the that print output will be from the printing device 20, and an example thereof is a UI 90 shown in FIG. 5. In the UI 90, a confirmation message (the confirmation screen) that reads “YOU ARE TRYING TO PRINT USING PRINTER OF VPN CONNECTION DESTINATION.CONTINUE?” and selection buttons “NO” and “YES” are displayed. In this embodiment, “NO” is the default selection button.

When, in response to this, the user selects “NO” (No in step S104), then the process ends without transmitting print data. When the user selects “YES” (Yes in step S104), then the print data is transmitted to the printing device 20 (step S105), and print output is thereby performed at the printing device 20.

As described above, the printer monitoring program 12A according to the first embodiment is a program corresponding to the print device 20 registered in the OS 9 of the information terminal 1, and when the printing device 20 is a VPN connection destination device, then before transmitting print data to the print device 20, the printer monitoring program 12A generates the UI 90 including a confirmation screen for confirming with the user that print output will be from the print device 20. Thus, the following effects can be obtained.

For security reasons, the user accesses the LAN 31 of the office area 30 from the out-of-office area 40 using the VPN 33. Therefore, when the printing device 20 is a device of the VPN connection destination, by displaying the UI 90 including a confirmation screen for confirming with the user that the print output will be from the printing device 20 before transmitting print data to the printing device 20, the UI 90 is displayed on the display section 3 of the information terminal 1 in the out-of-office area 40, thereby suppressing erroneous printing and ensuring security. In the office area 30, since UI 90 does not appear every time printing is performed, it is possible to suppress degradation in business efficiency.

### Second Embodiment

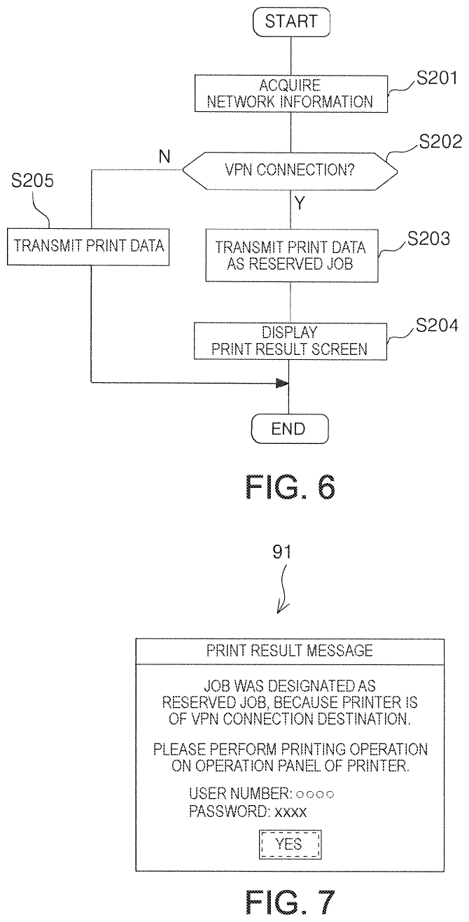

A second embodiment of the printer monitoring program 12 will be described with reference to FIGS. 6 and 7. Note that in the following description, the printer monitoring program according to the second embodiment will be described using reference numeral 12B.

FIG. 6 shows processes performed when the printer monitoring program 12B receives a print instruction from the application program 10. When the printer monitoring program 12B receives a print instruction from the application program 10, it acquires network information (step S201). In this embodiment, the network information is information indicating whether the information terminal 1 is VPN-connected, and when the information terminal 1 is VPN-connected by the OS 9 function, then, for example, information can be acquired from the OS 9.

Next, when the information terminal 1 is VPN-connected (Yes in step S202), then the printer monitoring program 12B controls the printer driver 11 to transmit print data to the printing device 20 as a reserved job (step S203). Here, reserved job means a job in which the printing device 20 does not immediately print out the print data, but temporarily stores the print data in the non-volatile memory 25 of the printing device 20. When, in response to this, the user inputs a user number and password using the operation section 21 of the printing device 20, then printing output is executed at the printing device 20.

The reserved job is an example of a print suspension process that suspends print output from the printing device 20 and stores the print data in the non-volatile memory 25, which is a storage section included in the printing device 20.

Next, the printer monitoring program 12B displays a print result screen on the display section 3 of the information terminal 1 (step S204). This print result screen is a screen for notifying the user that the print data has been transmitted to the printing device 20 as a reserved job, and an example thereof is a UI 91 shown in FIG. 7. In the UI 91, a confirmation message (the confirmation screen) that reads “JOB WAS DESIGNATED AS RESERVED JOB, BECAUSE PRINTER IS OF VPN CONNECTION DESTINATION.PLEASE PERFORM PRINTING OPERATION ON OPERATION PANEL OF PRINTER.”, a user number input column, a password input column, and a selection button of “YES” are displayed.

When, in response to this, the user selects “YES”, the process ends. When the information terminal 1 is not VPN-connected (No in step S202), then print data transmission is performed (step S205), and print output is performed at the printing device 20.

As described above, the printer monitoring program 12B according to the second embodiment is a program corresponding to the printing device 20 registered in the OS 9 of the information terminal 1, and designates it as a reserved job when the printing device 20 is a device of a VPN connection destination.

By this, erroneous printing can be suppressed in the out-of-office area 40, and security can be ensured. In addition, since selection and non-selection of the reserved job are automatically switched in this manner, it is possible to suppress a degradation in business efficiency.

### Third Embodiment

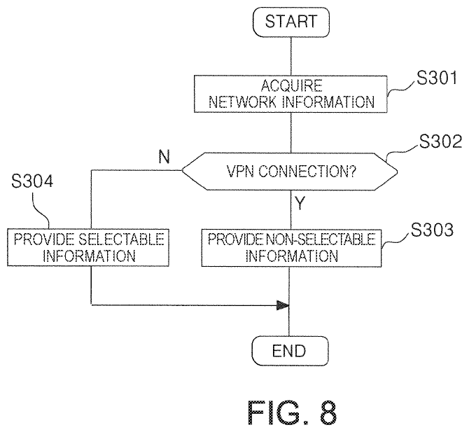

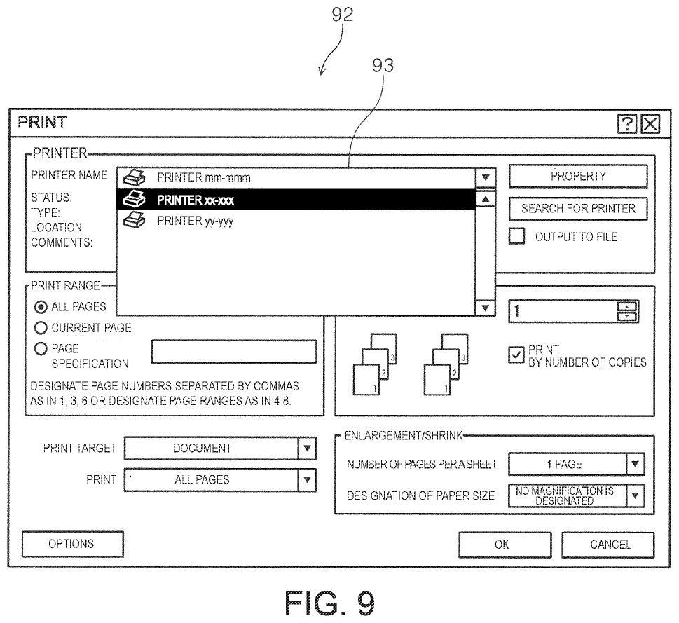

A third embodiment of the printer monitoring program 12 will be described with reference to FIGS. 8 and 9. Hereinafter, the printer monitoring program according to the third embodiment will be described using reference numeral 12C.

FIG. 8 shows a process when the print setting screen is selected in the application program 10. In this case, the printer monitoring program 12C acquires network information (step S301). The network information in this embodiment is information indicating whether the information terminal 1 is VPN-connected, and when the information terminal 1 is VPN-connected by the function of the OS 9, for example, then information can be acquired from the OS 9.

Next, when the information terminal 1 is VPN-connected (Yes in step S302), then the printer monitoring program 12C provides the application program 10 with information indicating that the printing device 20 is non-selectable (step S303). When the information terminal 1 is not VPN-connected (No in step S302), then the printer monitoring program 12C provides the application program 10 with information indicating that the printing device 20 is selectable (step S304).

FIG. 9 shows an example of a print setting UI 92 of the application program 10. In a pull-down menu 93, available devices among the devices selected in the OS 9 are displayed. The printing device 20 is displayed as “printer zz-zzz” if selectable, but will not be displayed in the pull-down menu 93 due to the operation of step S303 described above.

In this case, the printing device displayed in the pull-down menu 93 may be limited to a local connection printing device (for example, the printing device 44 at home).

As described above, the printer monitoring program 12C according to the third embodiment is a program corresponding to the printing device 20 registered in the OS 9 of the information terminal 1, and when the printing device 20 is a device of the VPN connection destination, then the printer monitoring program 12C provides the application program 10 with information indicating that the printing device 20 is non-selectable. Therefore, outside the office, the application program 10 does not show the printing device 20, so that erroneous printing can be suppressed, and security can be ensured. In addition, since the selectable state and the non-selectable state of the printing device 20 are automatically switched, it is possible to suppress degradation in business efficiency.

### Fourth Embodiment

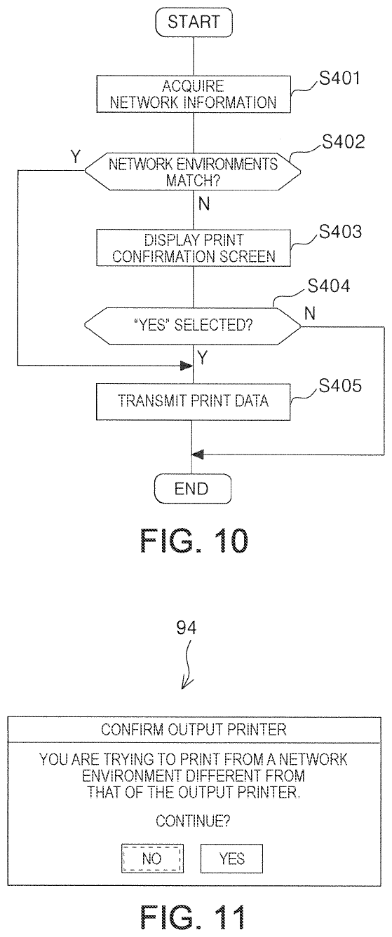

A fourth embodiment of the printer monitoring program 12 will be described with reference to FIGS. 10 and 11. In the following description, the printer monitoring program according to the fourth embodiment will be described using reference numeral 12D. FIG. 10 shows a process performed when the printer monitoring program 12D receives a print instruction from the application program 10. When the printer monitoring program 12D receives a print instruction from the application program 10, then it acquires network information (step S401). In this embodiment, the network information is information related to a network to which the printing device 20 is currently connected and information related to a network to which the information terminal 1 is currently connected. The information relating to the network to which the printing device 20 is currently connected is, for example, a local IP address of the printing device 20 on the LAN 31, an IP address of a default gateway (gateway 32), and the like. The information relating to the network to which the information terminal 1 is currently connected includes, for example, a local IP address of the information terminal 1 on the LAN 41, an IP address of a default gateway (gateway 42), and the like.

When the network environment to which the printing device 20 are connected is different from the network environment to which the information terminal 1 is connected (No in step S402), then the printer monitoring program 12D causes the display section 3 of the information terminal 1 to display a print confirmation screen (step S403).

Whether or not the network environment to which the printing device 20 is connected matches the network environment to which the information terminal 1 is connected may be determined using a plurality of pieces of network information or using one piece of network information. For example, the determination may be made based on only a network segment that can be acquired from the IP address, or may be made by adding other information such as the default gateway. Further, whether the network environment to which the printing device 20 is connected matches the network environment to which the information terminal 1 is connected may be determined only by other information such as the default gateway.

The print confirmation screen of step S403 is a confirmation screen for confirming with the user that print output is from the printing device 20, and an example of the confirmation screen is a UI 94 shown in FIG. 11. In the UI 94, the confirmation message (the confirmation screen) reads “YOU ARE TRYING TO PRINT FROM A NETWORK ENVIRONMENT DIFFERENT FROM THAT OF THE OUTPUT PRINTER. CONTINUE?” and selection buttons “NO” and “YES” are displayed. In this embodiment, “NO” is the default selection button.

When, in response to this, the user selects “NO” (No in step S404), then the process ends without transmitting the print data. When the user selects “YES” (Yes in step S404), then the print data is transmitted to the printing device 20 (step S405), and print output is thereby performed at the printing device 20.

As described above, when the network environment of the information terminal 1 is different from the network environment to which the printing device 20 belongs, then before transmitting print data to the printing device 20, the printer monitoring program 12D generates the UI 94 including a confirmation screen for confirming with a user about print output from the printing device 20. As a result, in the out-of-office area 40, the UI 94 is generated and displayed, so that erroneous printing can be suppressed and security can be ensured. In the office area 30, since the UI 94 does not appear every time printing is performed, it is possible to suppress a degradation in business efficiency.

### Fifth Embodiment

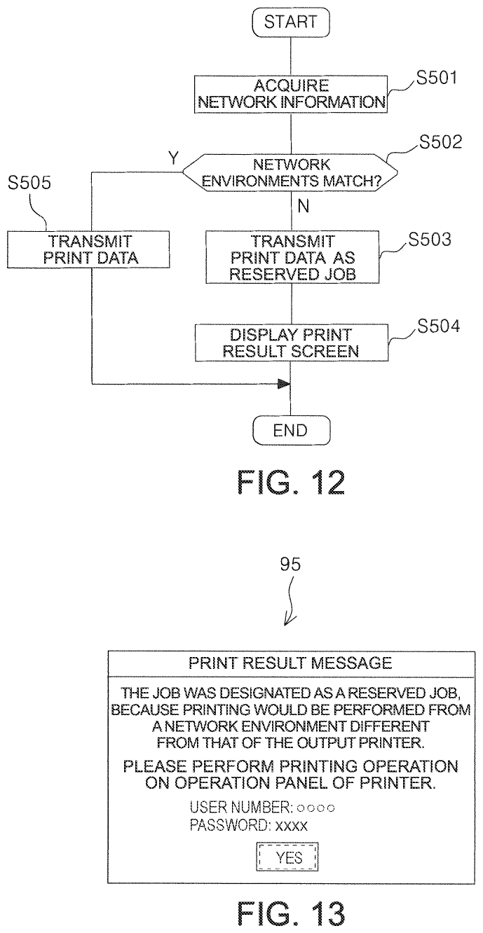

A fifth embodiment of the printer monitoring program 12 will be described with reference to FIGS. 12 and 13. In the following, the printer monitoring program according to the fifth embodiment will be described using reference numeral 12E. FIG. 12 shows processes performed when the printer monitoring program 12E receives a print instruction from the application program 10. When the printer monitoring program 12E receives a print instruction from the application program 10, it acquires network information (step S501). The acquisition of the network information is similar to step S401 in FIG. 10.

When the network environment to which the printing device 20 is connected is different from the network environment to which the information terminal 1 is connected (No in step S502), then the printer monitoring program 12E controls the printer driver 11 to transmit print data to the printing device 20 as a reserved job (step S503).

Then, the printer monitoring program 12E displays a print result screen on the display section 3 of the information terminal 1 (step S504). The print result screen is a screen for notifying the user that the print data has been transmitted to the printing device 20 as a reserved job, and an example thereof is a UI 95 shown in FIG. 13. In the UI 95, a confirmation message (the confirmation screen) that reads “THE JOB WAS DESIGNATED AS A RESERVED JOB, BECAUSE PRINTING WOULD BE PERFORMED FROM A NETWORK ENVIRONMENT DIFFERENT FROM THAT OF THE OUTPUT PRINTER. PLEASE PERFORM PRINTING OPERATION ON OPERATION PANEL OF PRINTER.”, a user number input column, a password input column, and a selection button of “YES” are displayed. When, in response to this, the user selects “YES”, then the process ends.

When the information on the network environment to which the printing device 20 is connected and the information on the network to which the information terminal 1 is connected are the same (Yes in step S502), then the printer monitoring program 12E transmits print data (step S505), and print output is thereby performed at the printing device 20.

As described above, the printer monitoring program 12E according to the fifth embodiment designates it as a reserved job when the network environment of the information terminal 1 is different from the network environment to which the printing device 20 belongs.

By this, erroneous printing can be suppressed in the out-of-office area 40, and security can be ensured. In addition, since selection and non-selection of the reserved job are automatically switched in this manner, it is possible to suppress a degradation in business efficiency.

### Sixth Embodiment

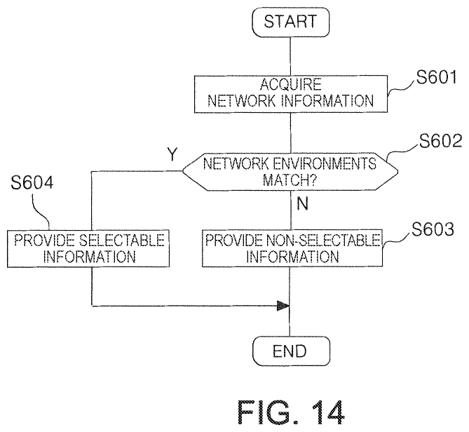

A sixth embodiment of the printer monitoring program 12 will be described with reference to FIG. 14. In the following, the printer monitoring program according to the sixth embodiment will be described using reference numeral 12F.

FIG. 14 shows processes when the print setting screen is selected in the application program 10. In this case, the printer monitoring program 12F acquires network information (step S601). The acquisition of the network information is similar to step S401 in FIG. 10.

Next, when the network environment to which the printing device 20 is connected is different from the network environment to which the information terminal 1 is connected (No in step S602), then the printer monitoring program 12F provides the application program 10 with information indicating that the printing device 20 is non-selectable (step S603). The determination in step S602 is performed in the same manner as in step S502 in FIG. 12.

If the network environment to which the printing device 20 is connected matches the network environment to which the information terminal 1 is connected (Yes in step S602), information indicating that the printing device 20 is SELECTABLE is provided to the application program 10 (step S604).

As described above, the printing device 20 will not be displayed in the pull-down menu 93 as in the print setting UI 92 illustrated in FIG. 9. In this case, the print device displayed in the pull-down menu 93 may be limited to a local connection printing device (for example, the printing device 44 at home).

In this way, the printer monitoring program 12F according to the sixth embodiment is a program corresponding to the printing device 20 that is registered in the OS 9 of the information terminal 1, wherein when the network environment of the information terminal 1 is different from the network environment to which the printing device 20 belongs, then the printer monitoring program 12F provides information that the printing device 20 is non-selectable to the application program 10. Therefore, outside the office, the application program 10 does not show the printing device 20, so that erroneous printing can be suppressed, and security can be ensured. In addition, since the selectable state and the non-selectable state of the printing device 20 are automatically switched, it is possible to suppress degradation in business efficiency.

### Seventh Embodiment

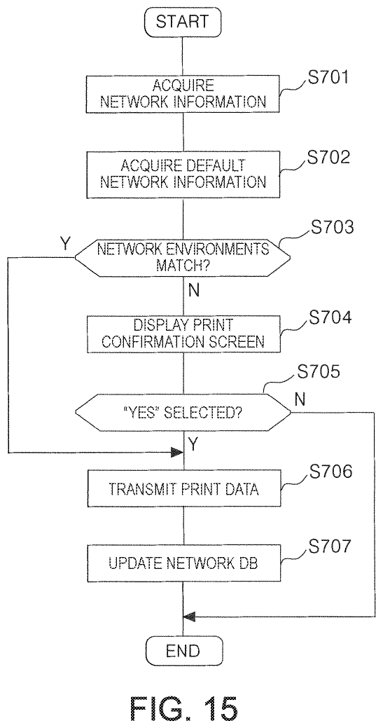

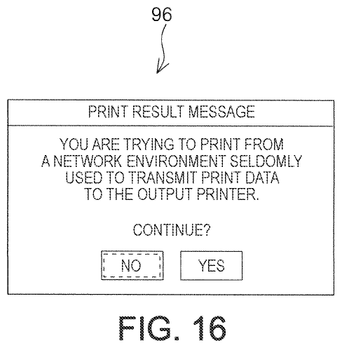

A seventh embodiment of the printer monitoring program 12 will be described with reference to FIGS. 15 and 16. In the following description, the printer monitoring program according to the seventh embodiment will be described using reference numeral 12G. FIG. 15 is a process performed when the printer monitoring program 12G receives a print instruction from the application program 10. When the printer monitoring program 12G receives a print instruction from the application program 10, it acquires network information (step S701). The network information acquired here is information relating to a network to which the information terminal 1 is currently connected, and is, for example, the local IP address of the information terminal 1 in the LAN 41, the IP address of a default gateway (the gateway 42), or the like.

Next, the printer monitoring program 12G acquires default network information (step S702). Here, the default network information is a database (hereinafter referred to as “DB”) updated by the printer monitoring program 12G, and is information included in a network DB stored in the storage 8 of the information terminal 1. The printer monitoring program 12G sends print data to the printing device 20 and, upon receiving information from the printing device 20 indicating that printing was completed normally, updates the network DB. The network DB includes, for example, a print date and time and network information (the local IP address of the information terminal 1, the IP address of the default gateway, and the like) of the information terminal 1 at that time.

The default network information indicates a network environment through which print output instructions to the printing device 20 are issued the most number of times, and is assumed to be the LAN 31 of the office area 30 as an example.

When the current network environment does not match the default network information (No in step S703), then the printer monitoring program 12G causes the display section 3 of the information terminal 1 to display a print confirmation screen (step S704). The determination in step S703 is performed in the same manner as in step S502 in FIG. 12.

This print confirmation screen is a confirmation screen for confirming with the user that print output will be from the printing device 20, and an example thereof is the UI 96 shown in FIG. 16. In FIG. 16 of the UI 96, the confirmation message (the confirmation screen) that reads “YOU ARE TRYING TO PRINT FROM A NETWORK ENVIRONMENT SELDOMLY USED TO TRANSMIT PRINT DATA TO THE OUTPUT PRINTER. CONTINUE?” and selection buttons “NO” and “YES” are displayed. In this embodiment, “NO” is the default selection button.

Correspondingly, when the user selects “NO” (No in step S705), the process ends without transmitting the print data. When the user selects “YES” (Yes in step S705), the print data is transmitted to the printing device 20 (step S706), and the print output is thereby performed at the printing device 20. Then, the printer monitoring program 12 updates the network DB (step S707).

When the current network environment matches the default network information (Yes in step S703), then the printer monitoring program 12G executes steps S706 and S707.

In this way, the printer monitoring program 12G is a program that corresponds to the printing device 20 registered in the OS 9 of the information terminal 1, wherein the network environment in which print output from the printing device 20 is performed the most in the past is defined as the default network environment, and when the network environment of the information terminal 1 is different from the default network environment, the printer monitoring program 12G generates the UI 95 including a confirmation screen for confirming with the user about print output from the printing device 20 before transmitting print data to the printing device 20. As a result, the UI 95 will appear in the out-of-office area 40, so that erroneous printing can be suppressed and security can be ensured. On the other hand, in the office area 30, since the UI 95 does not appear every time printing is performed, it is possible to suppress degradation in business efficiency.

### Eighth Embodiment

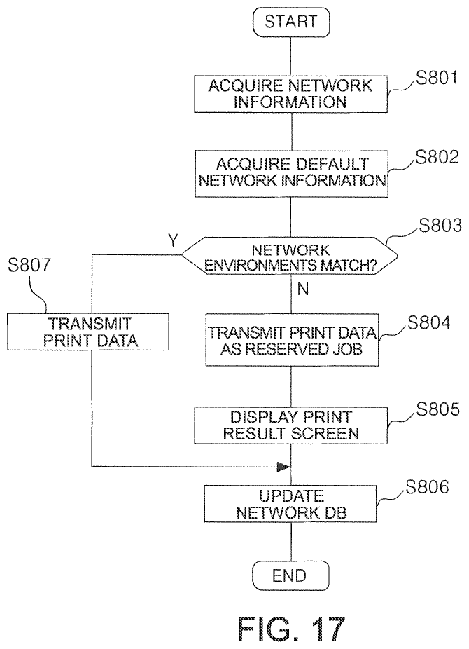

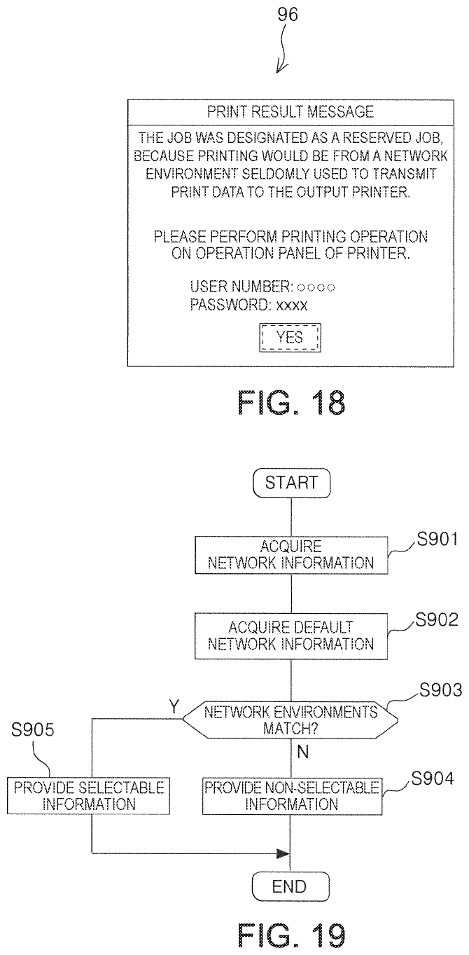

An eighth embodiment of the printer monitoring program 12 will be described with reference to FIGS. 17 and 18. In the following, the printer monitoring program according to the eighth embodiment will be described using reference numeral 12H. FIG. 17 shows processes performed when the printer monitoring program 12H receives a print instruction from the application program 10. When the printer monitoring program 12H receives a print instruction from the application program 10, it acquires network information (step S801). The acquisition of the network information is similar to step S701 in FIG. 15.

Next, the printer monitoring program 12H acquires default network information (step S802). If the current network environment does not match the default network information (No in step S803), then the printer driver 11 is controlled to transmit the print data to the printing device 20 as a reserved job (step S804).

Then, the printer monitoring program 12H displays a print result screen on the display section 3 of the information terminal 1 (step S805). The print result screen is a screen for notifying the user that the print data has been transmitted to the printing device 20 as a reserved job, and an example thereof is the UI 96 shown in FIG. 18. In FIG. 18 of the UI 96, the confirmation message (the confirmation screen) that reads “THE JOB WAS DESIGNATED AS A RESERVED JOB, BECAUSE PRINTING WOULD BE FROM A NETWORK ENVIRONMENT SELDOMLY USED TO TRANSMIT PRINT DATA TO THE OUTPUT PRINTER. PLEASE PERFORM PRINTING OPERATION ON OPERATION PANEL OF PRINTER.”, a user number input column, a password input column, and a selection button of “YES” are displayed. When, in response to this, the user selects “YES”, then the network DB is updated (step S806).

When the current network environment matches the default network information (Yes in step S803), then the printer monitoring program 12H transmits print data (step S807), so that print output is performed at the printing device 20. Then, the network DB is updated (step S806).

In this way, the printer monitoring program 12H is the printer monitoring program 12 corresponding to the print device 20 registered in the OS 9 of the information terminal 1, wherein a network environment in which print output from the printing device 20 is performed the most in the past is defined as a default network environment, and when the network environment of the information terminal 1 is different from the default network environment, it is designated as a reserved job. By this, erroneous printing can be suppressed in the out-of-office area 40, and security can be ensured. In addition, since the selectable state and the non-selectable state of the printing device 20 are automatically switched, it is possible to suppress degradation in business efficiency.

### Ninth Embodiment

A ninth embodiment of the printer monitoring program 12 will be described with reference to FIG. 19. In the following, the printer monitoring program according to the ninth embodiment will be described using reference numeral 12J.

FIG. 19 shows processes performed when the printer monitoring program 12J receives a print instruction from the application program 10. When the printer monitoring program 12J receives a print instruction from the application program 10, it acquires network information (step S901). The acquisition of the network information is similar to step S701 in FIG. 15.

Next, the printer monitoring program 12J acquires default network information (step S902). If the current network environment does not match the default network information (No in step S903), then information indicating that the printing device 20 is non-selectable is provided to the application program 10 (step S904). When the current network environment matches the default network information (Yes in step S903), information indicating that the printing device 20 is SELECTABLE is provided to the application program 10 (step S905).

As described above, the printing device 20 will not be displayed in the pull-down menu 93 as in the print setting UI 92 illustrated in FIG. 9. In this case, the print device displayed in the pull-down menu 93 may be limited to a local connection printing device (for example, the printing device 44 at home).

In this way, the printer monitoring program 12J is a program corresponding to the printing device 20 registered in the OS 9 of the information terminal 1, wherein the network environment in which print output from the printing device 20 was performed the most in the past is defined as the default network environment, and when the network environment of the information terminal 1 is different from the default network environment, the printer monitoring program 12J provides information that the printing device 20 is non-selectable to the application program 10 running on the OS 9. Accordingly, in the out-of-office area 40, the application program 10 does not show the printing device 20, and thus it is possible to suppress erroneous printing and to ensure security. In addition, since the selectable state and the non-selectable state of the printing device 20 are automatically switched, it is possible to suppress degradation in business efficiency.

As a means for suppressing erroneous printing, for example, the following means can be adopted in addition to the respective embodiments described above.
(1) When the information terminal 1 has established a VPN connection, all the printing devices registered in the OS 9 of the information terminal 1 are temporarily disabled, and the user manually enables necessary devices.
(2) When the information terminal 1 has established a VPN connection, only a preset printing device (for example, the printing device 44 at home) among the printing devices registered in the OS 9 of the information terminal 1 is enabled and all other printing devices are disabled.
(3) When the information terminal 1 has established a VPN connection, among the print devices registered in the OS 9 of the information terminal 1, only the locally connected printing device (for example, the printing device 44 at home) is enabled, and all other print devices are disabled.
(4) In a case where printing is directly executed from a specific system, for example, a server or the like in which personal information is stored using the information terminal 1, then when it is determined that the information terminal 1 and the printing device 20 are remote from each other, it is automatically designated as a reserved job. Whether the information terminal 1 and the printing device 20 are remote from each other can be determined by comparing the network environment of the information terminal 1 with the network environment of the printing device 20.
(5) When the information terminal 1 is used to directly execute printing from a specific system, for example, a server or the like in which personal information is stored, and when it is determined that the information terminal 1 and the printing device 20 are remote from each other, then personal information such as an address, a name, and a telephone number is printed out in an indiscernible state by being omitted or blacked out.

Further, the present disclosure is not limited to the embodiments and the modifications described above, and various modifications can be made within the scope of the disclosure described in the claims, and it goes without saying that such modifications are also included within the scope of the present disclosure.

What is claimed is:

1. A non-transitory computer readable storage medium storing a print control program, the print control program corresponding to a printing device registered in an operating system of an information terminal, the print control program comprising:
when the printing device is a device of a VPN connection destination,
generating, before transmitting print data to the printing device, a user interface including a confirmation screen to confirm with the user that print output is from the printing device.

2. A non-transitory computer readable storage medium storing a print control program, the print control program corresponding to a printing device registered in an operating system of an information terminal, the print control program comprising:
when the printing device is a device of a VPN connection destination,
selecting a print suspension process that suspends print output from the printing device and that stores print data in a storage section included in the printing device.

3. A non-transitory computer readable storage medium storing a print control program, the print control program corresponding to a printing device registered in an operating system of an information terminal, the print control program comprising:
when the printing device is a device of a VPN connection destination,
providing information that the printing device is non-selectable with respect to an application program running on the operating system.

4. A non-transitory computer readable storage medium according to claim 1, the print control program further comprising:
when a network environment of the information terminal is different from a network environment to which the printing device belongs,
generating, before transmitting print data to the printing device, a user interface including a confirmation screen to confirm with the user that print output is from the printing device.

5. A non-transitory computer readable storage medium according to claim 1, the print control program further comprising:
when a network environment of the information terminal is different from a network environment to which the printing device belongs,
selecting a print suspension process that suspends print output from the printing device and that stores print data in a storage section included in the printing device.

6. A non-transitory computer readable storage medium according to claim 1, the print control program further comprising:
when a network environment of the information terminal is different from a network environment to which the printing device belongs,
providing information that the printing device is non-selectable with respect to an application program running on the operating system.

7. A non-transitory computer readable storage medium according to claim 1, the print control program further comprising:
when a network environment of the information terminal is different from a default network environment, wherein the default network environment is defined as a network environment in which print output from the printing device was most performed in the past,
generating, before transmitting print data to the printing device, a user interface including a confirmation screen to confirm with the user that print output is from the printing device.

8. A non-transitory computer readable storage medium according to claim 1, the print control program further comprising:
when a network environment of the information terminal is different from a default network environment, wherein the default network environment is defined as a network environment in which print output from the printing device was most performed in the past,
selecting a print suspension process that suspends print output from the printing device and that stores print data in a storage section included in the printing device.

9. A non-transitory computer readable storage medium according to claim 1, the print control program further comprising:
when a network environment of the information terminal is different from a default network environment, wherein the default network environment is defined as a network environment in which print output from the printing device was most performed in the past,
providing information that the printing device is non-selectable with respect to an application program running on the operating system.

10. A non-transitory computer readable storage medium according to claim 1, the print control program further comprising:
the print control program executes displaying the confirmation screen on a display section.
